(19) United States
(12) Patent Application Publication
(10) Pub. No.: US 2025/0069572 A1
(43) Pub. Date: Feb. 27, 2025

(54) SCALE SHIFTING AND VOLUME ADJUSTMENT METHODS, APPARATUS, AND DEVICE

(71) Applicant: RINGWAY TECH (JIANGSU) CO., LTD., JIANGSU (CN)

(72) Inventors: Ping Zhao, JIANGSU (CN); Jianping Song, JIANGSU (CN); Guobin Chen, JIANGSU (CN); Peng Zhang, JIANGSU (CN); Haobo Ji, JIANGSU (CN)

(73) Assignee: RINGWAY TECH (JIANGSU) CO., LTD., JIANGSU (CN)

(21) Appl. No.: 18/811,883

(22) Filed: Aug. 22, 2024

Related U.S. Application Data
(60) Provisional application No. 63/578,357, filed on Aug. 23, 2023.

(51) Int. Cl. G10H 1/00; G10H 1/20; G10H 1/46

(52) U.S. Cl. CPC G10H 1/0008; G10H 1/20; G10H 1/46; G10H 2210/331

(57) ABSTRACT

The present disclosure relates to a scale shifting and volume adjustment method, apparatus and device, the method comprising obtaining air pressure difference; selecting a scale to be played corresponding to the air pressure difference according to a preset scale selection strategy; obtaining a volume value corresponding to the air pressure difference according to a preset volume acquisition strategy; adjusting the volume of the notes of the scale based on the volume value. The present disclosure is capable of automatically shifting scale according to the air pressure difference, and adjusting the volume in a convenient and hassle-free manner.

### CROSS-REFERENCES TO RELATED APPLICATIONS

This Non-Provisional Utility Patent Application claims the benefit of and priority to U.S. Provisional Application Ser. No. 63/578,357, filed Aug. 23, 2023, entitled “Scale Shifting and Volume Adjustment Methods, Apparatus, and Device,” the entire contents of which are hereby incorporated herein by reference.

### FIELD OF TECHNOLOGY

The present disclosure relates to the field of scale shifting and volume adjustment, and particularly to a scale shifting and volume adjustment method, apparatus and device.

### BACKGROUND

During performance of existing instruments, it is very troublesome to shift scales, which causes a great inconvenience for the performers, especially beginners, and is a great blow to the confidence of beginners.

### SUMMARY

The technical problem to be solved by the present disclosure is the defects of the prior art, and the present disclosure provides a convenient and hassle-free scale shifting and volume adjustment method that is capable of automatically shifting scales according to the air pressure difference, and adjusting the volume.

The technical solution of the present disclosure to solve the above technical problem is as follows: a scale shifting and volume adjustment method, comprising obtaining air pressure difference; selecting a scale to be played corresponding to the air pressure difference according to a preset scale selection strategy; obtaining a volume value corresponding to the air pressure difference according to a preset volume acquisition strategy; adjusting the volume of the notes of the scale based on the volume value.

Further, the method of obtaining air pressure difference comprises obtaining the current air pressure value from a sensor obtaining the air pressure difference based on the current air pressure value and a preset default air pressure value.

Further, selecting a scale to be played corresponding to the air pressure difference according to a preset scale selection strategy comprises determining the air pressure difference to be invalid if the air pressure difference≥first preset value; playing c² to b² on the scale chart if the first preset value≥air pressure difference

≥second preset value; playing c¹ to b¹ on the scale chart if the second preset value>air pressure difference≥third preset value; playing c to c⁵ on the scale chart if the air pressure difference<third preset value; in which the first preset value>the second preset value>the third preset value.

Further, the first preset value=3 times the third preset value, and the second preset value=2 times the third preset value.

Further, obtaining a volume value corresponding to the air pressure difference according to a preset volume acquisition strategy comprises processing the air pressure difference according to a preset air pressure difference processing strategy to obtain a processed value; finding a preset volume array based on the processed value to obtain a volume value corresponding to the processed value.

Further, processing the air pressure difference according to a preset air pressure difference processing strategy to obtain a processed value comprises if the air pressure difference≥the second preset value, the processed value=air pressure difference−the second preset value; if the second preset value>air pressure difference≥the third preset value, the processed value=air pressure difference−the third preset value; if the air pressure difference<the third preset value, the processed value=air pressure difference.

The present disclosure also provides a scale shifting and volume adjustment apparatus, comprising an air pressure difference acquisition module for obtaining the air pressure difference; a scale selection module for selecting a scale to be played corresponding to the air pressure difference according to a preset scale selection strategy; a volume acquisition module for obtaining a volume value corresponding to the air pressure difference according to a preset volume acquisition strategy; an adjustment module for adjusting the volume of the notes of the scale based on the volume value.

Further, the air pressure difference acquisition module comprises a receiving module for obtaining the current air pressure value from a sensor; a computing module for obtaining the air pressure difference based on the current air pressure value and a preset default air pressure value.

Further, the volume acquisition module comprises
a processing module for processing the air pressure difference according to a preset air pressure difference processing strategy to obtain a processed value; a lookup module for finding a preset volume array based on the processed value to obtain a volume value corresponding to the processed value

The present disclosure also provides a scale shifting and volume adjustment device, comprising a memory for storing a computer program; a processor for implementing the steps of the scale shifting and volume adjustment method when executing the computer program.

After adopting the above technical solution, the present disclosure selects the scale and volume value based on the air pressure difference, thereby achieving octave shifting of the scale, and adjusts the volume of the notes of the octave scale according to the volume value, thereby making it easy to shift the scale and adjust the volume, greatly reducing the difficulty of playing musical instruments.

### BRIEF DESCRIPTION OF THE DRAWINGS

FIG. 1 is a flow chart of a scale shifting and volume adjustment method in an example of the present disclosure;

FIG. 2 is a scale chart in an example of the present disclosure;

FIG. 3 is a flow chart of the selection of a scale and volume based on an air pressure value in an example of the present disclosure;

FIG. 4 is a structural block diagram of a scale shifting and volume adjustment apparatus in an example of the present disclosure;

FIG. 5 is a structural block diagram of an air pressure difference acquisition module in an example of the present disclosure;

FIG. 6 is a structural block diagram of a volume acquisition module in an example of the present disclosure;

FIG. 7 is a structural block diagram of a scale shifting and volume adjustment device in an example of the present disclosure.

### DETAILED DESCRIPTION

For easier and clearer understanding of the contents of the present example, the present example is described in further detail below with the specific embodiments and drawings.

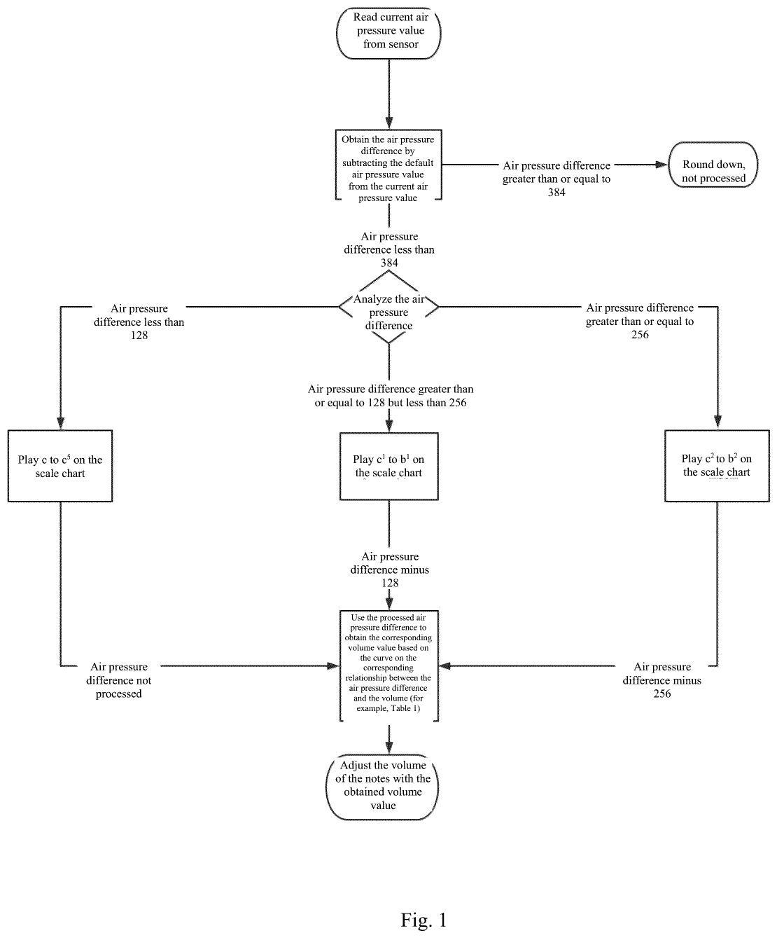

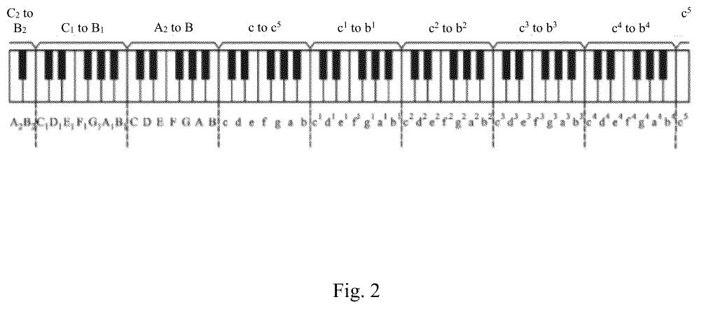

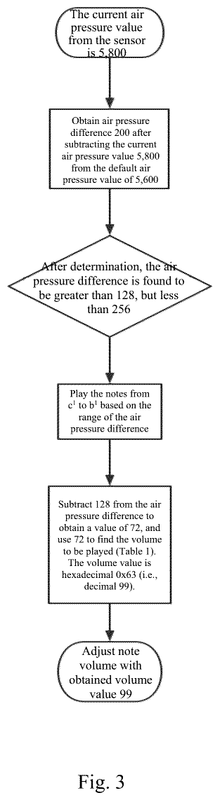

As shown in FIG. 1, a scale shifting and volume adjustment method, comprising obtaining air pressure difference; selecting a scale to be played corresponding to the air pressure difference according to a preset scale selection strategy; obtaining a volume value corresponding to the air pressure difference according to a preset volume acquisition strategy; adjusting the volume of the notes of the scale based on the volume value.

Specifically, the present example selects the scale and volume value based on the air pressure difference, thereby achieving octave shifting of the scale, and adjusts the volume of the notes of the octave scale according to the volume value, thereby making it easy to shift the scale and adjust the volume, greatly reducing the difficulty of playing musical instruments.

In one example, the method of obtaining air pressure difference comprises obtaining the current air pressure value from a sensor
obtaining the air pressure difference based on the current air pressure value and a preset default air pressure value.

In one example, the default air pressure value is 5,600, but is not limited thereto.

In one example, selecting a scale to be played corresponding to the air pressure difference according to a preset scale selection strategy comprises determining the air pressure difference to be invalid if the air pressure difference≥first preset value; playing c² to b² on the scale chart if the first preset value>air pressure difference
≥second preset value; playing c¹ to b¹ on the scale chart if the second preset value>air pressure difference≥third preset value; playing c to c⁵ on the scale chart if the air pressure difference<third preset value; in which the first preset value>the second preset value>the third preset value.

In one example, the first preset value=3 times the third preset value, and the second preset value=2 times the third preset value.

Specifically, the present example divides the air pressure difference into multiple segments, and each segment corresponds to an octave scale, thereby achieving octave shifting.

In one example, obtaining a volume value corresponding to the air pressure difference according to a preset volume acquisition strategy comprises processing the air pressure difference according to a preset air pressure difference processing strategy to obtain a processed value;
finding a preset volume array based on the processed value to obtain a volume value corresponding to the processed value.

Specifically, if the processed value is set as i, the volume value corresponding to the processed value i is the value of the ith element of the volume array.

In one example, processing the air pressure difference according to a preset air pressure difference processing strategy to obtain a processed value comprises if the air pressure difference≥the second preset value, the processed value=air pressure difference−the second preset value; if the second preset value>air pressure difference≥the third preset value, the processed value=air pressure difference−the third preset value; if the air pressure difference<the third preset value, the processed value=air pressure difference.

In one example, the first preset value is 384, the second preset value is 256, and the third preset value is 128, but are not limited thereto.

In one example, the volume array is BlowCurve [128]={0x0c, 0x0d, 0x0e, 0x10, 0x11, 0x12, 0x12, 0x13, 0x14, 0x15, 0x16, 0x17, 0x18,
0x19, 0x19, Ox1a, 0x1b, Ox1d, Ox1e, 0x1f, 0x20, 0x22, 0x23, 0x24, 0x25, 0x27, 0x28,
0x29, 0x2a, 0x2c, 0x2d, 0x2e, 0x30, 0x31, 0x33, 0x34, 0x36, 0x37, 0x39, 0x3a, 0x3c,
0x3d, 0x3f, 0x40, 0x41, 0x43, 0x44, 0x45, 0x46, 0x48, 0x49, 0x4a, 0x4b, 0x4d, 0x4e,
0x4f, 0x50, 0x52, 0x53, 0x54, 0x55, 0x57, 0x58, 0x59, 0x5a, 0x5c, 0x5d, 0x5e, 0x5f,
0x60, 0x61, 0x62, 0x63, 0x65, 0x66, 0x67, 0x68, 0x69, 0x6a, 0x6b, 0x6c, 0x6d, 0x6d,
0x6e, 0x6f, 0x6f, 0x70, 0x70, 0x71, 0x72, 0x72, 0x73, 0x74, 0x74, 0x75, 0x75, 0x76,
0x77, 0x77, 0x78, 0x79, 0x79, 0x7a, 0x7a, 0x7b, 0x7c, 0x7c, 0x7d, 0x7e, 0x7e, 0x7f, 0x7f, 0x7f, 0x7f, 0x7f, 0x7f, 0x7f, 0x7f, 0x7f, 0x7f, 0x7f, 0x7f, 0x7f, 0x7f, 0x7f, 0x7f, 0x7f, 0x7f,}.

Specifically, after the air pressure difference is processed according to the air pressure difference processing strategy, the corresponding volume value of each processed value is guaranteed to be found in the volume array.

The technical solution involved in the above examples is described below with an optional example.

Read the current air pressure value 5,800 from the sensor; obtain air pressure difference 200 after subtracting the current air pressure value

5,800 from the default air pressure value of 5,600; after determination, the air pressure difference is found to be 200, which is greater than 128, but less than 256; play the notes from c¹ to b¹ based on the range of the air pressure difference; subtract 128 from the air pressure difference to obtain 72, and use 72 to find the volume array to obtain the volume value, hexadecimal 0x63, i.e. decimal 99; use volume 99 to adjust the volume of notes from c¹ to b¹.

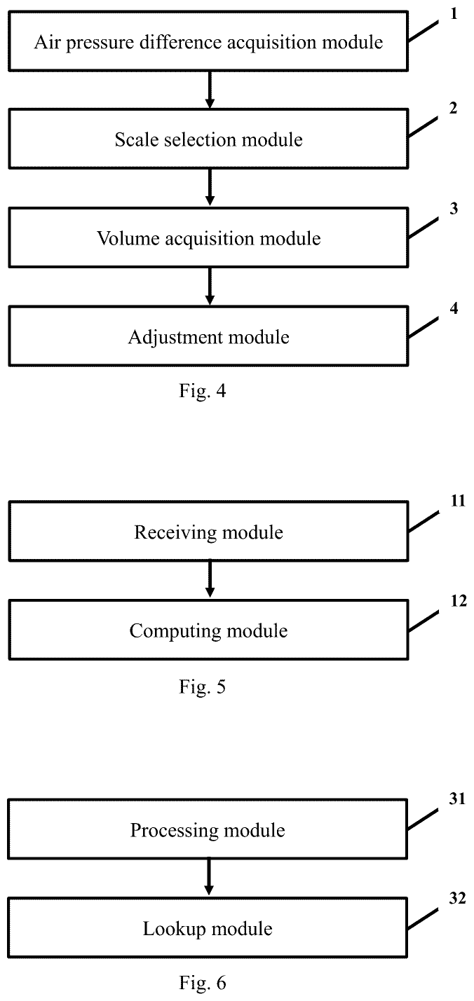

FIG. 4 is a structural block diagram of a scale shifting and volume adjustment apparatus provided by an example of the present disclosure, and the scale shifting and volume apparatus comprises an air pressure difference acquisition module 1 for obtaining air pressure difference; a scale selection module 2 for selecting a scale to be played corresponding to the air pressure difference according to a preset scale selection strategy;
a volume acquisition module 3 for obtaining a volume value corresponding to the air pressure difference according to a preset volume acquisition strategy; an adjustment module 4 for adjusting the volume of the notes of the scale based on the volume value.

In one example, as shown in FIG. 5, the air pressure difference acquisition module 1 comprises:
a receiving module 11 for obtaining the current air pressure value from a sensor; a computing module 12 for obtaining the air pressure difference based on the current air pressure value and a preset default air pressure value.

In one example, as shown in FIG. 6, the volume acquisition module 3 comprises: a processing module 31 for processing the air pressure difference according to a preset air pressure difference processing strategy to obtain a processed value; a lookup module 32 for finding a preset volume array based on the processed value to obtain a volume value corresponding to the processed value

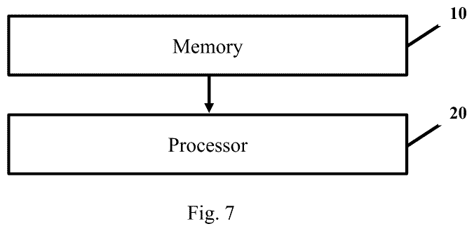

FIG. 7 is a structural block diagram of a scale shifting and volume adjustment device provided by an example of the present disclosure, and the scale shifting and volume adjustment device comprises a memory 10 for storing a computer program; a processor 20 for implementing steps of the above scale shifting and volume adjustment method when executing the computer program.

Based on the revelations of the above ideal examples of the present disclosure, people skilled in the relevant art are capable of making various changes and modifications to the above description without departing from the technical idea of the present disclosure. The technical scope of the present disclosure is not limited to the content in the Specification, and the technical scope must be determined according to the scope of the Claims.

1. A scale shifting and volume adjustment method, comprising:
obtaining air pressure difference; selecting a scale to be played corresponding to the air pressure difference according to a preset scale selection strategy;
obtaining a volume value corresponding to the air pressure difference according to a preset volume acquisition strategy; and
adjusting the volume of the notes of the scale based on the volume value.

2. The scale shifting and volume adjustment method of claim 1, wherein the method of obtaining air pressure difference comprises obtaining the current air pressure value from a sensor obtaining the air pressure difference based on the current air pressure value and a preset default air pressure value.

3. The scale shifting and volume adjustment method of claim 1, wherein selecting a scale to be played corresponding to the air pressure difference according to a preset scale selection strategy comprises determining the air pressure difference to be invalid if the air pressure difference≥first preset value;
playing c² to b² on the scale chart if the first preset value>air pressure difference≥second preset value;
playing c¹ to b¹ on the scale chart if the second preset value>air pressure difference≥third preset value; and
playing c to c⁵ on the scale chart if the air pressure difference<third preset value,
in which the first preset value>the second preset value>the third preset value.

4. The scale shifting and volume adjustment method of claim 3, wherein the first preset value=3 times the third preset value, and the second preset value=2 times the third preset value.

5. The scale shifting and volume adjustment method of claim 1, wherein obtaining a volume value corresponding to the air pressure difference according to a preset volume acquisition strategy comprises processing the air pressure difference according to a preset air pressure difference processing strategy to obtain a processed value; and
finding a preset volume array based on the processed value to obtain a volume value corresponding to the processed value.

6. The scale shifting and volume adjustment method of claim 5, wherein processing the air pressure difference according to a preset air pressure difference processing strategy to obtain a processed value comprises if the air pressure difference≥the second preset value, the processed value=air pressure difference−the second preset value;
if the second preset value>air pressure difference≥the third preset value, the processed value=air pressure difference−the third preset value; and
if the air pressure difference<the third preset value, the processed value=air pressure difference.

7. The scale shifting and volume adjustment method of claim 6, further comprising:
memory that stores a computer program; and
one or more processors that implement the steps of the scale shifting and volume adjustment method from the computer program in memory.

8. A scale shifting and volume adjustment apparatus, comprising an air pressure difference acquisition module for obtaining air pressure difference;
a scale selection module for selecting a scale to be played corresponding to the air pressure difference according to a preset scale selection strategy; a volume acquisition module for obtaining a volume value corresponding to the air pressure difference according to a preset volume acquisition strategy; and
an adjustment module for adjusting the volume of the notes of the scale based on the volume value.

9. The scale shifting and volume adjustment apparatus of claim 8, wherein the air pressure difference acquisition module comprises a receiving module for obtaining the current air pressure value from a sensor;
a computing module for obtaining the air pressure difference based on the current air pressure value and a preset default air pressure value.

10. The scale shifting and volume adjustment apparatus of claim 9, wherein the volume acquisition module comprises a processing module for processing the air pressure difference according to a preset air pressure difference processing strategy to obtain a processed value;
a lookup module for finding a preset volume array based on the processed value to obtain a volume value corresponding to the processed value.
